(19) United States
(12) Patent Application Publication
(10) Pub. No.: US 2023/0296294 A1
(43) Pub. Date: Sep. 21, 2023

(54) SIMPLIFIED CRYOGENIC REFRIGERATION SYSTEM

(71) Applicant: Cryostar SAS, Hesingue (FR)

(72) Inventor: Guillaume PAGES, Pullach (DE)

(21) Appl. No.: 18/040,938

(22) PCT Filed: Aug. 3, 2021
(86) PCT No.: PCT/EP2021/025293

§ 371 Date: Feb. 7, 2023

(30) Foreign Application Priority Data
Aug. 12, 2020 (EP) 20315384.6

(51) Int. Cl. F25B 9/10; F25B 9/06; F17C 3/10

(52) U.S. Cl. CPC F25B 9/10; F25B 9/06; F17C 3/10; F17C 2221/033; F17C 2227/0355; F17C 2223/0161

(57) ABSTRACT

Simplified closed loop refrigeration system adapted for cryogenic temperatures comprising: a gaseous refrigerant circulating inside the closed loop refrigeration system, a compression section for compressing the refrigerant with at least two compressor stages, at least one of the compressor stages being one centrifugal compressor, at least a motor producing mechanical power to drive at least one of the compressor stages, at least an after cooler after each compression stage, a first heat exchanger for additionally cooling the compressed refrigerant, at least one expansion turbine for expanding the compressed refrigerant, a second heat exchanger for exchanging heat between the expanded refrigerant and an external fluid, a heating section where the expanded refrigerant is heated in counter-current flow inside the first heat-exchanger by the compressed refrigerant, wherein at least one centrifugal compressor being driven only by the expansion turbine and the centrifugal compressors and the expansion turbine use magnetic bearings.

The present invention relates to a simplified cryogenic refrigeration system.

More particularly, the present invention is related to the refrigeration of liquefied natural gas (LNG) or to the refrigeration of other cryogenic liquids, like liquid hydrogen. The invention also relates to a method for operating a refrigeration system according to the invention, and to the use of such refrigeration system and method aboard a LNG carrier.

### BACKGROUND OF THE INVENTION

Natural gas can be stored and transported in liquid state as LNG, at cryogenic temperatures colder than −150° C., typically −161° C., inside insulated tanks. Despite the continuous efforts to improve their insulation properties, theses tanks are subject to unavoidable heat ingresses, resulting in the warming-up and boiling-off of a small quantity of the stored LNG, also known as boil-off gas or BOG.

EP 1 660 608 B1 discloses an apparatus for controlled storage of liquefied gases such as LNG, where a part of the liquid stored inside the tank is withdrawn and cooled down by an external refrigeration system before being reintroduced into the tank. The LNG being cooled down to a temperature lower than its boiling point, this is also referred as subcooling. In that way, the inevitable heat-ingresses inside the storage tank are compensated by the additional subcooling of the LNG, and the generation of BOG can be minimized or even totally avoided.

Suitable external refrigeration systems are similar to the one disclosed in document N. Saji et al, “DESIGN OF OIL FREE SIMPLE TURBO TYPE 65 k/6 kw HELIUM AND NEON MIXTURE GAS REFRIGERATOR FOR HIGH TEMPERATURE SUPERCONDUCTING POWER CABLE COOLING” CP 613, advances in cryogenic engineering; Proceedings of the cryogenic engineering conference, vol. 47, 2002. These refrigeration systems typically comprise a closed circuit where a refrigerant or a mixture of different refrigerants is circulating. The refrigeration system further comprises one or many compressors to compress the refrigerant, one or many coolers to cool-down the compressed refrigerant, one heat exchanger to further cool-down the refrigeration, one or many means for depressurizing the refrigerant, one heat exchanger to exchange heat between the refrigerant and a fluid to subcool, and one heat-exchanger to warm-up the refrigerant before it is re-compression, thus achieving a complete thermodynamic cycle inside the closed loop of the refrigeration system.

The cooling power of these refrigeration systems is typically adjusted by changing the quantity of refrigerant inside the closed loop. If more cooling power is needed, refrigerant is added to the closed loop, and symmetrically, if less cooling power is needed, refrigerant is withdrawn from the closed loop.

Such refrigeration systems require rather complex rotating machineries, like a high-speed motor driving on one end a compressor and on another end an expansion turbine. These high speed motors are complex, made to order high-speed motor and must be specifically adapted to drive an impeller, compressor or expander, one on each extremities of the motor shaft.

WO 2009 136 793 A1 discloses that suitable refrigeration systems can also use another kind of rotating machineries where all compression and expansion stages are arranged in a common skid called a “compander”, on which integral gearbox common to all stages is driven by a single electrical motor. Such machines are of great mechanical complexity because of the multiple shafts and pinions necessary to drive each one of the compression and expansion stages.

It is thus an object of the present invention to provide an improved closed loop refrigeration system, which avoids the above disadvantages.

### SUMMARY OF THE INVENTION

The object is solved by a closed loop refrigeration system according to claim 1, a method for operating said closed loop refrigeration system according to claim 13 and a LNG carrier comprising a closed loop refrigeration system according to claim 15.

The dependent claims refer to preferred embodiments of the invention.
Thus, the invention provides a simplified closed loop refrigeration system for cooling an external fluid, comprising:
a compression section for compressing a refrigerant, the compression section comprising a first compressor and a second compressor, the first compressor being a centrifugal compressor,
a first motor producing mechanical power to drive the second compressor,
a first after cooler being arranged downstream of the first compressor for cooling the compressed refrigerant after the first compressor,
a second after cooler being arranged downstream of the second compressor for cooling the compressed refrigerant after the second compressor,
a first heat exchanger being arranged downstream of the first after cooler and the second after cooler for further cooling the compressed refrigerant,
an expansion turbine being arranged downstream of the first heat exchanger for expanding the compressed refrigerant,
a second heat exchanger being arranged downstream of the turbine for exchanging heat between the expanded refrigerant and an external fluid to cool the external fluid,
a heating section forming a part of the first heat exchanger and being arranged downstream of the second heat exchanger in which the expanded refrigerant is heated by indirect heat exchange with the compressed refrigerant,
   Characterized in that:
the first, centrifugal compressor is directly mechanically connected to only the expansion turbine and is driven only by the expansion turbine,
the first, centrifugal compressor and the expansion turbine each comprise magnetic bearings.

The term “downstream” means with regards to the direction of flow of the refrigerant trough the refrigeration system.

The term “directly” is primarily to be understood that the first compressor has only one single shaft, which is only connected to a single component, and this single component is the expansion turbine, i.e. the first compressor is only driven by the turbine. The first compressor is not connected to a motor or to a gearbox, not directly and not indirectly via an other component of the refrigeration system.

The terms first and second do not indicate the arrangement with regards to the flow of refrigerant but are merely used for clarity of enumeration.

Advantageously, the power produced by the expansion of the refrigerant within the expansion turbine can be recovered and used to directly drive one of the compressor, that is to say without high-speed motor or gearbox mechanically connected between the expander and the compressor

Preferably, the expansion turbine is a centripetal expansion turbine.

It is advantageous that the second compressor is mechanically connected to only the first motor and is driven only by the first motor, wherein the first motor is in particular a water-cooled electrical motor.

The second compressor can be centrifugal compressor.

In another preferred embodiment, the closed loop refrigeration cycle comprises a third centrifugal compressor, in particular arranged downstream of the second centrifugal compressor, for compressing the refrigerant, wherein the third centrifugal compressor is mechanically connected to only a second motor and is driven only by the second motor, wherein in particular the second motor is a water-cooled electrical motor, and wherein in particular a third after cooler is being arranged downstream of the third centrifugal compressor for cooling the compressed refrigerant, the second electrical motor (52) being water-cooled independently from the first electrical motor (5;51).

It is also possible to use a single screw compressor driven by one electrical motor instead of several centrifugal compressors driven by several electrical motors.

To avoid any pollution of the refrigeration loop by lube oil, it is also possible to use a dry screw compressor

To limit the losses of refrigerant to the outside environment, an hermetic or a semi-hermetic screw compressor can be used.

Preferably, the second compressor is downstream the first centrifugal compressor directly.

To further reduce leakages paths between the refrigeration loop and the outside environment, the first motor which drives the screw compressor is a magnetically coupled motor.

It is possible that the first and second heat exchangers are combined into a single unit, which is in particular a plate-fin heat exchanger.

According to a second aspect, the present invention relates to a method for operating a cryogenic refrigeration system, comprises the steps of:
Providing a refrigerant to the refrigeration system
Adjusting the refrigeration cycle cooling power by changing the speed of rotation of the motor driving the compressor. In that way, when the cooling capacity must be increased, the flow of gaseous refrigerant inside the loop is be increased by increasing the speed of rotation of the compressor.
Letting the centripetal expander and the centrifugal compressor driven only by said centripetal expander freely spinning.

The gaseous refrigerant can comprise at least one component chosen from a group comprising He, Ne, N2, CH4.

The gaseous refrigerant can also comprise at least two components chosen from a group comprising He, Ne, N2, CH4.

A third aspect for which protection is sought, but which also represents an embodiment of the present invention according to the first and second aspects, is directed to a LNG carrier comprising a refrigeration system according to the invention.

### BRIEF DESCRIPTION OF THE DRAWINGS

FIG. 1a illustrates a first embodiment where all compressors are centrifugal compressors.

FIG. 1b illustrates another embodiment of a system according to the invention.

FIG. 2a illustrates a second embodiment where one compressor is a screw compressor, the other compressor being a centrifugal compressor directly driven by the expansion turbine.

FIG. 2b illustrates another embodiment of a system according to the invention.

### DETAILED DESCRIPTION OF THE DRAWINGS

In the following, the different embodiments according to the Figures are discussed comprehensively, same reference signs indicating same or essentially same units. It is appreciated that a person skilled in the art may combine certain components of an embodiment shown in a figure with the features of the present invention as defined in the appended claims without the need to include more than this certain component or even all other components of this embodiment shown in said Figures.

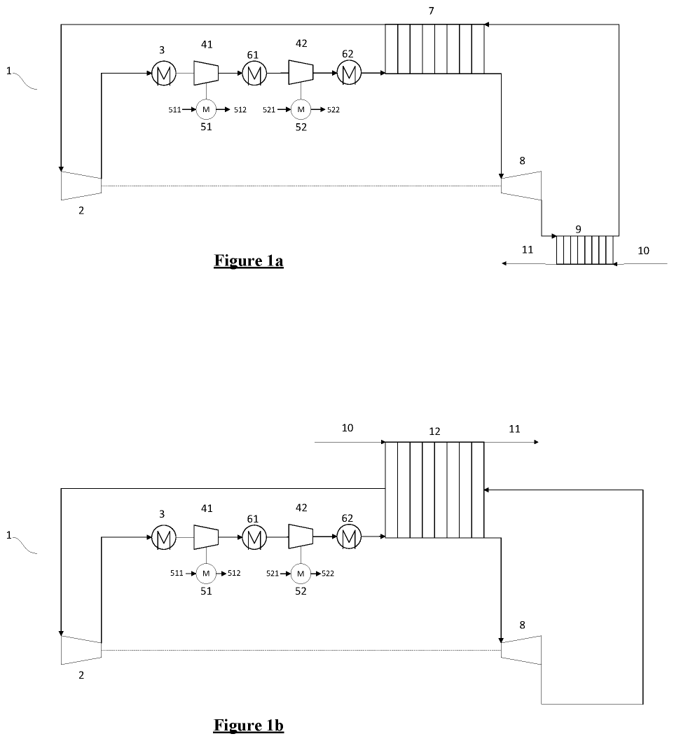

FIG. 1a schematically shows a closed loop refrigeration system (1) according to a first embodiment of the invention, comprising a first centrifugal compressor (2) for compressing a refrigerant, a first after cooler (3) for cooling the refrigerant compressed by the first centrifugal compressor (2), a second centrifugal compressor (41) for further compressing the refrigerant, the second centrifugal compressor being directly driven by a first water-cooled electrical motor (51), a second aftercooler (61) for cooling the refrigerant compressed by the second centrifugal compressor (41), a third centrifugal compressor (42) for further compressing the refrigerant, the third centrifugal compressor (42) being directly driven by a second water cooled electrical motor (52), a third aftercooler (62) for cooling the refrigerant compressed by the third centrifugal compressor, a first heat exchanger with a cooling section located downstream the third after cooler for further cooling the refrigerant, an expansion turbine downstream the cooling section for depressurizing the refrigerant, a second heat exchanger (9) being arranged downstream of the turbine (8) for exchanging heat between the expanded refrigerant and an external fluid to cool the external fluid, a heating section forming a part of the first heat exchanger (7) and being arranged downstream of the second heat exchanger (9) in which the expanded refrigerant is heated by indirect heat exchange with the compressed refrigerant,

For example, the external fluid (10) fluid to be cooled can be LNG pumped from one of the storage tanks of a LNG carrier, subcooled by the closed loop refrigeration system according to the invention, and then re-injected inside the storage tank to compensate for the heat-ingresses inside the storage tank.

For a 170 000 m3 LNG carrier having an insulation with a Boil-off rate of 0.07%/day—that is the performances of the storage tank insulation are such that every day 0.07% of the full capacity of the tank evaporates due to said heat ingresses—a refrigeration system must compensate for 250 kW heat ingresses by subcooling 45 M3/hr of LNG from −161° C. to −172° C.

That amount of thermal energy is therefore absorbed by the gaseous refrigerant in heat exchange with the LNG from the tanks through heat exchanger (9).

The first compressor stage (2) is directly driven by the expansion turbine (8), without any electrical motor or gearbox between the first compressor stage directly driven by the expansion turbine and the turbine to balance to power requirement of the first compressor (2) with the mechanical power recovered from the expansion of the gaseous refrigerant by the expansion turbine. That is to say that the power of the compressor directly driven by the expansion turbine is equal to the power recovered by the expansion turbine, minus the inevitable friction losses.

The second and third centrifugal compressor stages (41, 42) are individually driven by their respective electrical motors (51, 52) and their respective electrical motors being water-cooled independently of each others, that is to say that the water-cooling streams (511; 512) of the electrical motor (51) of second compressor stage are separated and independently adjusted from the water cooling streams (521; 522) of the electrical motor (52) of the third compressor stage.

In operation, if the heat ingresses, and therefore the temperature of the LNG and/or the pressure of the gas in the ullage space of the storage tank, change, the cooling power of the refrigeration system is adjusted by changing the speed of rotation of the electrical motors (51, 52) with variable frequency drives (not shown). For example, if the cooling power must be decreased, the speed of rotation of the electrical motors (51, 52) is decreased, thus reducing inlet capacity of the second and third centrifugal compressors stages (41, 42), and therefore reducing the flow of gaseous refrigerant circulation inside the refrigeration loop. The compressor stage directly driven by the expansion turbine is left spinning at free speed, accordingly to the volume flow of gaseous refrigerant.

FIG. 1b shows the embodiment of FIG. 1a, where first heat exchanger (7) and second heat exchanger (9) are merged together to form a single unit (12). This embodiment is particularly advantageous when single unit (12) is a plate-fin type heat exchanger, as this greatly reduce the footprint of the cryogenic refrigeration system according to the invention, and allows more efficient heat transfer.

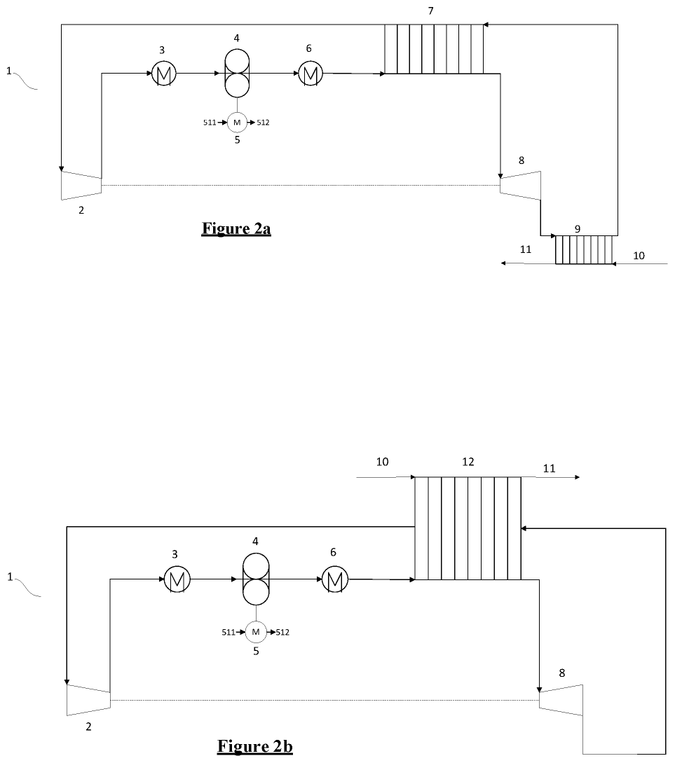

FIG. 2a schematically shows a closed loop refrigeration system (1) according to a first embodiment of the invention, comprising a first compressor (2) for compressing a refrigerant, the first compressor (2) being a centrifugal compressor, a first after cooler (3) for cooling the refrigerant compressed by the first centrifugal compressor (2), a second compressor (4) for further compressing the refrigerant, the second compressor being a screw compressor and is directly driven by a water-cooled electrical motor (5), a second after cooler (6) for cooling the refrigerant compressed by the second compressor (41), a first heat exchanger with a cooling section located downstream the third after cooler for further cooling the refrigerant, an expansion turbine downstream the cooling section for depressurizing the refrigerant, a second heat exchanger (9) being arranged downstream of the turbine (8) for exchanging heat between the expanded refrigerant and an external fluid to cool the external fluid, a heating section forming a part of the first heat exchanger (7) and being arranged downstream of the second heat exchanger (9) in which the expanded refrigerant is heated by indirect heat exchange with the compressed refrigerant,

For a 170 000 m3 LNG carrier having an insulation with a Boil-off rate of 0.07%/day—that is the performances of the storage tank insulation are such that every day 0.07% of the full capacity of the tank evaporates due to said heat ingresses—a refrigeration system must compensate for 250 kW heat ingresses by subcooling 45 M3/hr of LNG from −161° C. to −172° C.

That amount of thermal energy is therefore absorbed by the gaseous refrigerant in heat exchange with the LNG from the tanks through heat exchanger (9).

The first compressor stage (2) is directly driven by the expansion turbine (8), without any electrical motor or gearbox between the first compressor stage directly driven by the expansion turbine and the turbine to balance to power requirement of the first compressor (2) with the mechanical power recovered from the expansion of the gaseous refrigerant by the expansion turbine. That is to say that the power of the compressor directly driven by the expansion turbine is equal to the power recovered by the expansion turbine, minus the inevitable friction losses.

The screw compressor (4) is directly driven by a single electrical motor (5). The single electrical motor (5) driving the screw compressor (4) is water-cooled by water-cooling stream (511; 512)

In operation, if the heat ingresses, and therefore the temperature of the LNG and/or the pressure of the gas in the ullage space of the storage tank, change, the cooling power of the refrigeration system is adjusted by changing the speed of rotation of the electrical motor (5) with variable frequency drives (not shown). For example, if the cooling power must be decreased, the speed of rotation of the electrical motor (5) is decreased, thus reducing inlet capacity of the screw compressor (4), and therefore reducing the flow of gaseous refrigerant circulation inside the refrigeration loop. The compressor stage directly driven by the expansion turbine is left spinning at free speed, accordingly to the volume flow of gaseous refrigerant.

FIG. 2b shows the embodiment of FIG. 1a, where first heat exchanger (7) and second heat exchanger (9) are merged together to form a single unit (12). This embodiment is particularly advantageous when single unit (12) is a plate-fin type heat exchanger, as this greatly reduce the footprint of the cryogenic refrigeration system according to the invention, and allows more efficient heat transfer.

### LIST OF REFERENCE SIGNS

(1): Closed loop refrigeration system
(41), (42), (2), (4): compressor stages
(61), (62), (3): after coolers
(51), (52), (5): electrical motors
(7), (8): first and second heat exchangers
(9): expansion turbine.
(10): LNG withdrawn from storage tank
(11): subcooled LNG re-injected into storage tank
(12): single unit heat exchanger
(511; 512): watercooling streams of the first electrical motor
(521; 522): watercooling streams of the second electrical motor

1. A closed loop refrigeration system for cooling an external fluid, comprising:
a compression section for compressing a refrigerant, the compression section comprising a first compressor and a second compressor, the first compressor being a centrifugal compressor,
a first motor producing mechanical power to drive the second compressor,
a first after cooler being arranged downstream of the first compressor for cooling the compressed refrigerant after the first compressor,
a second after cooler being arranged downstream of the second compressor for cooling the compressed refrigerant after the second compressor,
a first heat exchanger being arranged downstream of the first after cooler and the second after cooler for further cooling the compressed refrigerant,
an expansion turbine being arranged downstream of the first heat exchanger for expanding the compressed refrigerant,
a second heat exchanger being arranged downstream of the turbine for exchanging heat between the expanded refrigerant and an external fluid to cool the external fluid,
a heating section forming a part of the first heat exchanger and being arranged downstream of the second heat exchanger in which the expanded refrigerant is heated by indirect heat exchange with the compressed refrigerant, wherein
the first, centrifugal compressor is directly mechanically connected to only the expansion turbine and is driven only by the expansion turbine,—the first, centrifugal compressor and the expansion turbine each comprise magnetic bearings.

2. The closed loop refrigeration system according to claim 1, wherein the expansion turbine is a centripetal expansion turbine.

3. The closed loop refrigeration cycle according to claim 1, wherein the second compressor is mechanically connected to only the first motor and is driven only by the first motor, wherein the first motor is in particular a water-cooled electrical motor.

4. The closed loop refrigeration system according to claim 1, wherein the second compressor is a centrifugal compressor.

5. The closed loop refrigeration cycle according to claim 1, wherein it comprises a third centrifugal compressor, in particular arranged downstream of the second centrifugal compressor, for compressing the refrigerant, wherein the third centrifugal compressor is mechanically connected to only a second motor and is driven only by the second motor, wherein in particular the second motor is a water-cooled electrical motor, and wherein in particular a third after cooler is being arranged downstream of the third centrifugal compressor for cooling the compressed refrigerant, the second electrical motor being water-cooled independently from the first electrical motor.

6. The closed loop refrigeration system according to claim 1, wherein characterized in that the second compressor is a screw compressor.

7. The closed loop refrigeration system according to claim 6, wherein the second compressor is a dry screw compressor.

8. The closed loop refrigeration system according to claim 6, wherein characterized in that the second compressor is an hermetic or a semi-hermetic dry screw compressor.

9. The closed loop refrigeration system according to claim 1, wherein the second compressor is downstream the first centrifugal compressor.

10. The closed loop refrigeration system according to claim 6, wherein the first motor which drives the screw compressor is a magnetically coupled motor.

11. The closed loop refrigeration system according to claim 1, wherein the first and second heat exchangers are combined into a single unit, which is in particular a plate-fin heat exchanger.

12. A method for operating a cryogenic refrigeration system according to claim 1, comprising the steps of:
providing a refrigerant to the refrigeration system
adjusting the refrigeration cycle cooling power by changing the speed of rotation of the first motor, in particular and/or by changing the speed of rotation of the second motor
letting the expansion turbine and the first, centrifugal compressor directly mechanically connected to only the expansion turbine and driven only by the expansion turbine freely spinning.

13. The method for operating a closed loop refrigeration system according to claim 12, wherein at least one component of the refrigerant is chosen from a group comprising He, Ne, N2, CH4.

14. The method for operating a closed loop refrigeration system according to claim 13, wherein at least two components of the refrigerant are chosen from a group comprising He, Ne, N2, CH4.

15. An LNG carrier comprising a refrigeration system according to claim 1.
